(19) United States
(12) Patent Application Publication
(10) Pub. No.: US 2023/0329940 A1
(43) Pub. Date: Oct. 19, 2023

(54) INDOOR MOBILITY SYSTEM WITH TRACKED SUSPENSION

(71) Applicant: Darryl Harrod, Washington, DC (US)

(72) Inventor: Darryl Harrod, Washington, DC (US)

(21) Appl. No.: 17/563,595

(22) Filed: Dec. 28, 2021

(51) Int. Cl. A61G 7/10

(52) U.S. Cl. CPC A61G 7/1042; A61G 7/1059; A61G 7/1088; A61G 7/1098; A61G 7/1092

(57) ABSTRACT

An indoor mobility system with tracked suspension includes a track, a trolley that travels upon the track, a seat which can carry an occupant, and a mount which suspends the seat from the trolley. Controls mounted to the seat permit the occupant to move the trolley along the track in one of two directions, thereby transporting the occupant with it. Tracks may be run along a ceiling of a structure so that the user can traverse the interior without walking. Forming the track, two U-shaped channels mirror and open up towards each other, and wheels upon the trolley span this gap, being constrained between the channels. The trolley features a two-piece hinged carriage that provides stability to the seat carried upon it while also being able to pass through curved sections of the track. An electric motor may drive one or more wheels of the trolley to propel the system.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of mobility systems of existing art and more specifically relates to an indoor tracked mobility system.

### RELATED ART

Individuals who suffer from reduced use of their motive capabilities struggle not only in travelling outside of their home, but inside of it as well. While the use of walkers and wheelchairs are able to do much to renew lost motive ability, these assisting devices have disadvantages. They are bulky and cumbersome, require much effort to operate, are inadequate for traversing stepped changes in floor surfaces, and are inflexible in their adjustability. In a home space, the daily inconvenience of these obstacles can be overwhelming. It is desired that there should be a mobility solution optimized for residential use, which can be tailored to a specific indoor space, which does not require significant physical effort to operate, and which the user is able to remain seated in.

There exist several solutions in the art in an attempt to implement improved ceiling-mounted mobility systems. Among these are U.S. Pat. Nos. 6,523,195, 6,079,578, 5,809,591, and 4,944,056. However, none of these attempted solutions is seen as sufficient in providing a convenient residential system for everyday use. Accordingly, there is yet perceived a need for an improved solution incorporating additional comfort and usability features, while also providing an improved track and trolley system which will be efficient, reliable, and unobtrusive in a home environment.

### SUMMARY OF THE INVENTION

In view of the foregoing disadvantages inherent in the known mobility system art, the present disclosure provides a novel indoor mobility system with tracked suspension. The general purpose of the present disclosure, which will be described subsequently in greater detail, is to provide an indoor mobility system with tracked suspension.

The disclosed indoor mobility system with tracked suspension includes a track, a trolley that travels upon the track, a seat which can carry an occupant, and a mount which suspends the seat from the trolley. Controls mounted to the seat permit the occupant to move the trolley along the track in one of two directions, thereby transporting the occupant with it. Tracks may be run along a ceiling of a structure so that the user can traverse the interior without walking. Forming the track, two U-shaped channels mirror and open up towards each other, and wheels upon the trolley span this gap, being constrained between the channels. The trolley features a two-piece hinged carriage that provides stability to the seat carried upon it while also being able to pass through curved sections of the track. An electric motor may drive one or more wheels of the trolley to propel the system.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an indoor mobility system with tracked suspension, constructed and operative according to the teachings of the present disclosure.

FIG. 1 is a perspective view of the indoor tracked mobility system during an ‘in-use’ condition transporting a user within a residence, according to an embodiment of the disclosure.

FIG. 2 shows the indoor tracked mobility system of FIG. 1, according to an embodiment of the present disclosure.

FIG. 3 is a perspective view of the mount and seat assemblies of the indoor tracked mobility system of FIG. 1, according to an embodiment of the present disclosure.

FIGS. 4A and 4B are perspective views of the trolley of the indoor tracked mobility system of FIG. 1, according to an embodiment of the present disclosure.

FIGS. 5A and 5B are perspective views of the seat assembly of the indoor tracked mobility system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a mobility device and more particularly to an indoor mobility system with tracked suspension as used to improve the traversability of a home for disabled individuals.

Generally, the indoor mobility system with tracked suspension may be a semi-permanent or permanent infrastructure retrofitted to the interior of the structure to provide a mobility solution for individuals who struggle to traverse their home. A track structure may be suspended from the ceiling of the structure along travel paths within the home. This track structure may support a trolley which engages the track with electrically motivated wheels. The trolley may support a seat structure, in which a user may be seated.

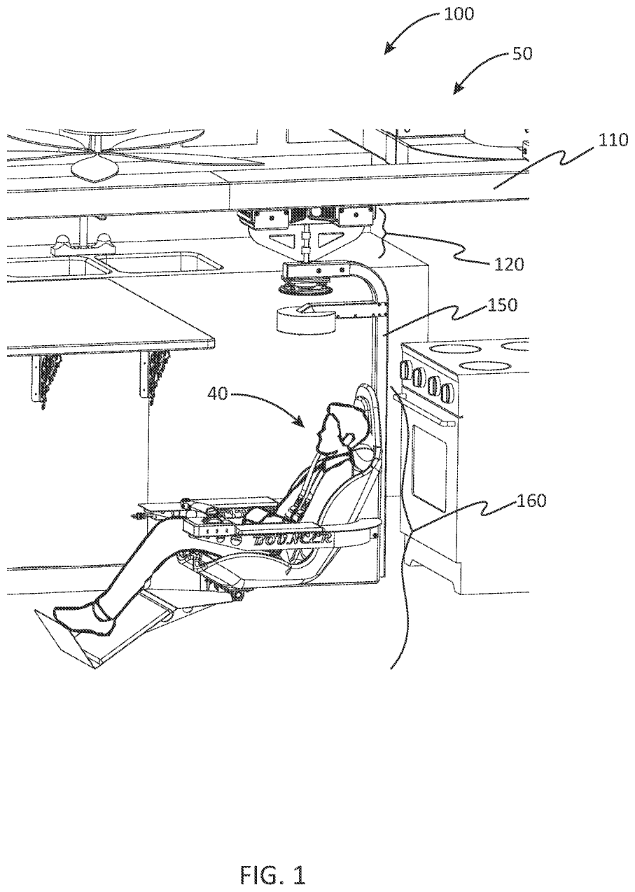

Referring now more specifically to the drawings by numerals of reference, there is shown in FIGS. 1-5, various views of an indoor mobility system 100.

FIG. 1 shows an indoor tracked mobility system during an ‘in-use’ condition 50, according to an embodiment of the present disclosure. Here, the indoor tracked mobility system may be beneficial for use by a user 40 to traverse the interior of a structure, especially when user 40 suffers from mobility constraints. As illustrated, the indoor tracked mobility system 100 may include track 110, trolley 120 traveling upon track 110, seat assembly 160 supporting user 40 for transportation within the structure, and suspension mount 150 suspending seat assembly 160 from trolley 120.

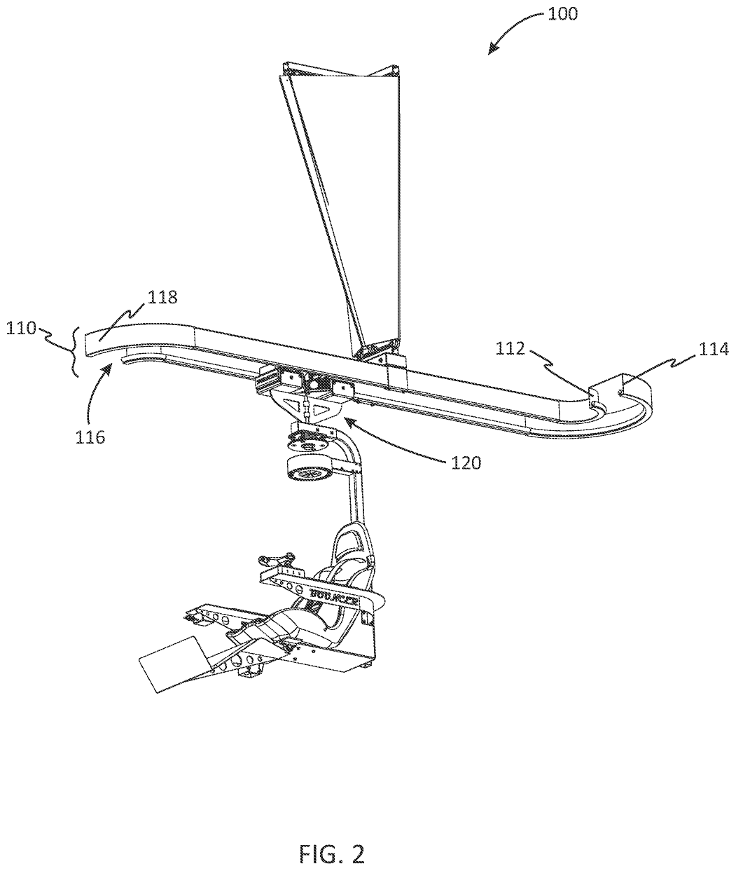

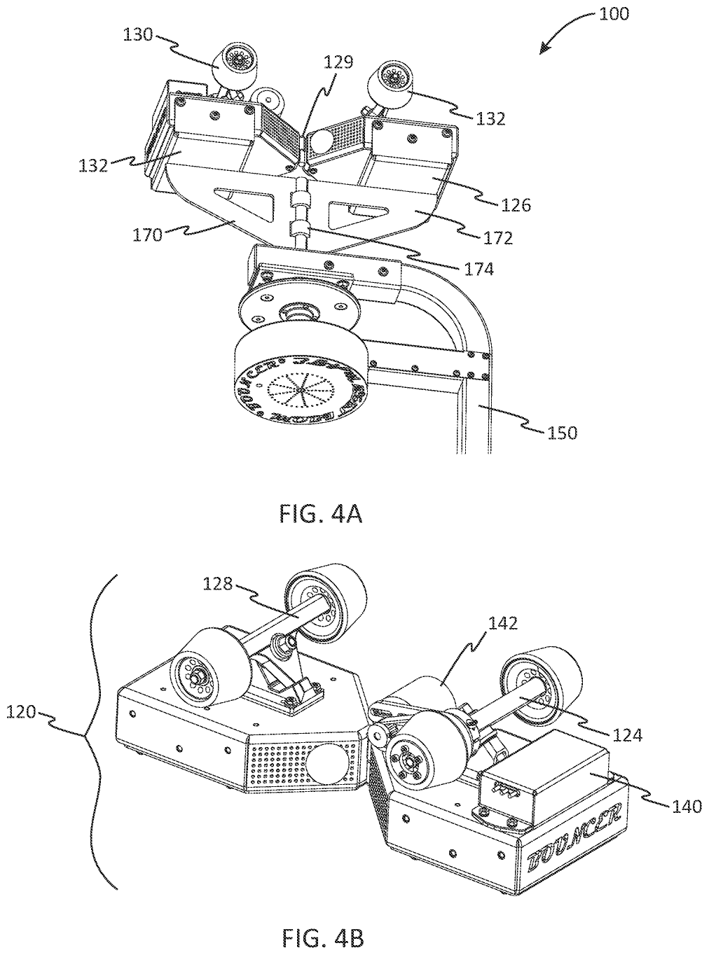

FIG. 2 shows the indoor tracked mobility system of FIG. 1, according to an embodiment of the present disclosure. As shown, track 110 may have left-channel 112 and right-channel 114, being separated by a space able to be spanned by trolley 120, such that right-channel 114 mirrors left-channel 112. Each of left-channel 112 and right-channel are defined by one open side 116 and three closed sides 118, and the one open side 116 of left-channel 112 faces the one open side 116 of right-channel 114, left-channel 112 and right-channel 114 being separated by a gap which is sufficiently wide to accept the first-axle 124 (FIG. 4B) and the second-axle 128 (FIG. 4B), and sufficiently narrow to contain and laterally and vertically constrain the first-pair of wheels 130 (FIG. 4A) and the second-pair of wheels 132 (FIG. 4A) within the left-channel 112 and the right-channel 114. Trolley 120 may be slidably engagable with track 110 when installed between left-channel 112 and right-channel 114.

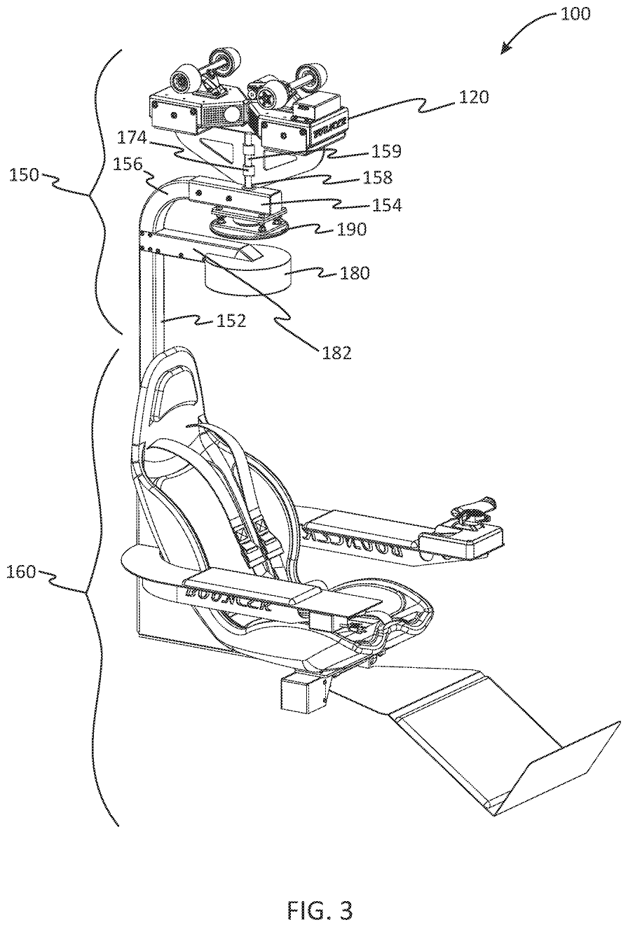

FIG. 3 is a perspective view of the mount and seat assemblies of the indoor tracked mobility system of FIG. 1, according to an embodiment of the present disclosure. Indoor mobility system 100 may include seat assembly 160 and mount 150 suspending the seat from trolley 120. Mount 150 itself may be characterized by vertical-member 152, trolley-member 154, and bend 156. Vertical-member 152 may be aligned with a backrest of seat assembly 160. Trolley-member 154 may be able to rigidly affix to trolley 120. Bend 156 may join vertical-member 152 to trolley-member 154 at an angle greater than forty-five degrees, and preferably at ninety degrees, as in the preferred embodiment vertical-member 152 should be normal to trolley-member 154. Vertical-member 152, trolley-member 154, and bend 156 may be a single unitary component, being constructed out of square tube steel in some embodiments. Mount 150 may also include swivel 158 coupling trolley-member 154 of mount 150 to trolley 120, swivel 158 having sufficient articulation to enable rotation of mount 150 relative to trolley 120 by at least two-hundred and seventy degrees. However, swivel 158 may not be included in all embodiments; alternative embodiments may affix mount 150 rigidly to trolley 120. In such an embodiment, trolley-member 154 may be affixed directly to center-pin 159 passing through brace-hinge 174. Bracket 190 may fasten trolley-member 154 to center-pin 159 in this way. Yet further, accessory station 180 may be affixed to mount 150 upon cantilever 182, providing a multitude of accessory functions.

FIGS. 4A and 4B are perspective views of the trolley of the indoor tracked mobility system of FIG. 1, according to an embodiment of the present disclosure. Trolley 120 slidably engageable with track 110 when first-axle 124 spans left-channel 112 (FIG. 2) and right-channel 114 (FIG. 2), such that first-pair of wheels is able to roll along and within each of left-channel 112 (FIG. 2) and right-channel 114 (FIG. 2). Likewise, second-axle may span left-channel 112 (FIG. 2) and right-channel 114 (FIG. 2), such that second-pair of wheels is able to roll along and within each of left-channel 112 (FIG. 2) and right-channel 114 (FIG. 2).

Trolley 120 may have first-carriage 122, second-carriage 126, and hinge 129 pivotably affixing first-carriage 122 to second-carriage 126. First-carriage 122 pivots relative to second-carriage 126 on an axis which would bifurcate track 110 between left-channel 112 (FIG. 2) and right-channel 114 (FIG. 2). In this way, trolley 120 may articulate between the first axle and the second axle so that trolley is able to navigate arcuate portions of track 110 (FIG. 2) without binding within left-channel 112 (FIG. 2) and right-channel 114 (FIG. 2). As shown, first-axle 124 may be mounted to first-carriage 122, and second-axle 128 mounted to second-carriage 126, such that first-carriage 122 and second-carriage 126 are suspended below the track 110 (FIG. 2) and the axles. This may be accomplished by rigid axle mounts; it may not be necessary in all embodiments that each axle spin relative to trolley 120. In some embodiments, each wheel may spin upon a fixed axle shaft. However, it may also be that one or more axles may spin to drive one or more drive wheels, with an electric motor driving the axle. Yet further, gear drives, belt drives, chain drives, transmissions, and multi-shaft axles may be implemented. In any case, first-pair of wheels 130 may be mounted to first-axle 124, and second-pair of wheels 132 may likewise be mounted to second-axle 128. When trolley 120 is installed to track 110 (FIG. 2), each wheel of first-pair of wheels 130 and second-pair of wheels 132 may be able to fit within and slidably engage with either left-channel 112 (FIG. 2) and right-channel 114 (FIG. 2), trolley 120 being thereby constrained between left-channel 112 (FIG. 2) and right-channel 114 (FIG. 2) when each of first-pair of wheels 130 and second-pair of wheels 132 are together engaged with left-channel 112 (FIG. 2) and right-channel 114 (FIG. 2). At least one electric motor 142 may be able to selectively rotate at least one of the first-wheel, second-wheel, third-wheel, and fourth-wheel, and may be battery-operated. Trolley-controller 140 may be able to selectively energize at least one electric motor 142 in two rotational directions. Each wheel of first-pair of wheels 130 and second-pair of wheels 132 may be axially tapered, such that a diametrically smaller end of each wheel of first-pair of wheels 130 and second-pair of wheels 132 face outwardly from trolley 120.

First-carriage 122 may also include first-brace 170, and second-carriage 126 may also include second-brace 172. First-brace 170 and second-brace 172 may themselves be pivotably joined by brace-hinge 174, which may be used accordingly to suspend mount 150. Accordingly, first-brace 170 and second-brace 172 are designed to suspend significant weight from trolley 120. Likewise, brace-hinge 174 should be strong and large in girth to support the weight of mount 150, seat assembly 160 (FIG. 1), and user 40 (FIG. 1).

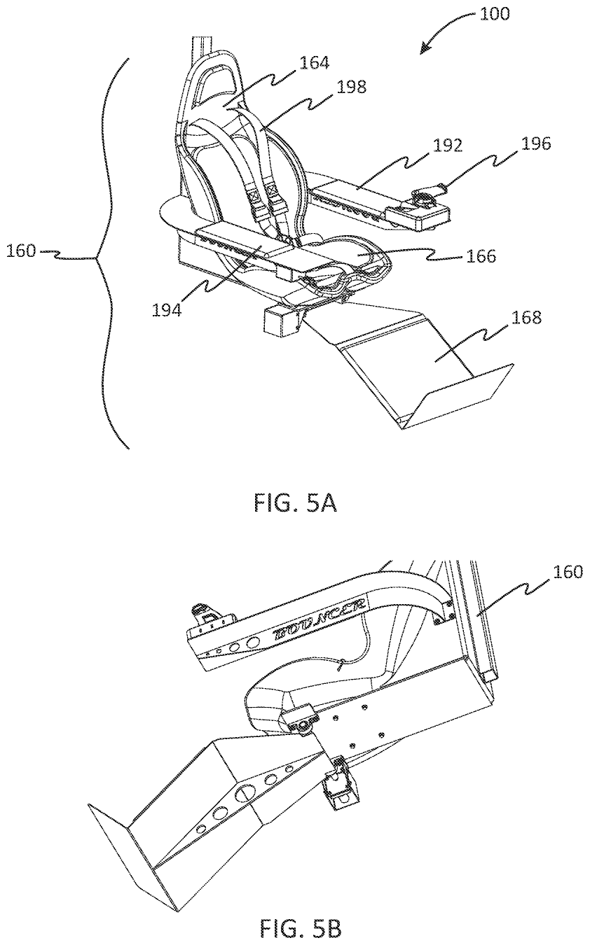

FIGS. 5A and 5B are perspective views of the seat assembly of the indoor tracked mobility system of FIG. 1, according to an embodiment of the present disclosure. Seat assembly 160 may have rigid frame 162, backrest 164 mounted to rigid frame 162, seat-bottom 166 mounted to rigid frame 162, and footrest 168 hingedly affixed to rigid frame 162. Footrest 168 may be adjustable in angulation relative to rigid frame 162. Each of left-armrest 192 and right-armrest 194 may be mounted to rigid frame 162. Control-panel 196 may be is in electrical communication with trolley-controller 140, able to send digital commands to move trolley 120 (FIG. 1) in either direction along track 110 (FIG. 1). Restraints 198 may be affixed to backrest 164 in order to secure user 40 (FIG. 1).

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An indoor mobility system, the indoor mobility system comprising:
a track having
a left-channel, and
a right-channel,
such that each of the left-channel and right-channel are defined by one open side and three closed sides, and the one open side of the left-channel faces the one open side of the right-channel;
a trolley slidably engagable with the track, the trolley having
a first-carriage,
a second-carriage,
a hinge pivotably affixing the first-carriage to the second-carriage,
a first-axle mounted to the first-carriage,
a second-axle mounted to the second-carriage,
a first-pair of wheels mounted to the first-axle, and
a second-pair of wheels mounted to the second-axle,
at least one electric motor able to selectively rotate at least one of the first-wheel, second-wheel, third-wheel, and fourth-wheel, and
a trolley-controller able to selectively energize the at least one electric motor in two rotational directions,
whereby each wheel of the first-pair of wheels and the second-pair of wheels are able to fit within and slidably engage with either the left-channel and the right-channel, the trolley being thereby constrained between the left-channel and the right-channel when each of the first-pair of wheels and the second-pair of wheels are together engaged with the left-channel and the right-channel;
a seat assembly; and
a mount suspending the seat from the trolley;
wherein the left-channel and the right-channel are separated by a gap which is sufficiently wide to accept the first-axle and the second-axle, and sufficiently narrow to contain and laterally and vertically constrain the first-pair of wheels and the second-pair of wheels within the left-channel and the right-channel.

2. The indoor mobility system of claim 1, wherein each wheel of the first-pair of wheels and the second-pair of wheels are axially tapered, such that a diametrically smaller end of each wheel of the first-pair of wheels and the second-pair of wheels face outwardly from the trolley.

3. The indoor mobility system of claim 1, wherein the mount comprises
a vertical-member aligned with a backrest of the seat assembly,
a trolley-member able to rigidly affix to the trolley,
a bend joining the vertical-member to the trolley-member at an angle greater than forty-five degrees,

4. The indoor mobility system of claim 1, further comprising
a swivel coupling the trolley-member of the mount to the trolley, the swivel having sufficient articulation to enable rotation of the mount relative to the trolley by at least two-hundred and seventy degrees.

5. The indoor mobility system of claim 1, further comprising
an accessory station affixed to the mount

6. The indoor mobility system of claim 1, wherein the seat assembly comprises
a rigid frame;
a backrest mounted to the rigid frame;
a seat-bottom mounted to the rigid frame;
a footrest hingedly affixed to the rigid frame;
a left-armrest mounted to the rigid frame;
a right-armrest mounted to the rigid frame; and
a control-panel which is in electrical communication with the trolley-controller.
